(19) United States
(12) Patent Application Publication
(10) Pub. No.: US 2014/0349132 A1
(43) Pub. Date: Nov. 27, 2014

(54) METHOD FOR MANUFACTURING A COMPACT COMPONENT, AND COMPONENT THAT CAN BE PRODUCED BY MEANS OF THE METHOD

(71) Applicant: Fraunhofer-Gesellschaft zur Forderung der angewandten Forschung, Munchen (DE)

(72) Inventors: Eckart Uhlmann, Kiebitzreihe (DE); Jens Gunster, Clausthal-Zellerfeld (DE); Cynthia Morais Gomes, Berlin (DE); Andre Bergmann, Berlin (DE); Kamilla Koenig-Urban, Berlin (DE)

(21) Appl. No.: 14/366,778

(22) PCT Filed: Nov. 27, 2012
(86) PCT No.: PCT/EP2012/073672

§ 371 Date: Jun. 19, 2014

(30) Foreign Application Priority Data
Dec. 20, 2011 (DE) 10 2011 089 194.3

(51) Int. Cl. B28B 11/24; B32B 3/26

(52) U.S. Cl. CPC B28B 11/24; B32B 3/266; B32B 2250/02; B32B 2264/10; B32B 2305/38
USPC 428/596; 264/642; 264/442; 428/137

(57) ABSTRACT

The invention relates to a method for producing a compact component (10) comprising a shell (12) and optionally a grid structure (14) situated inside the shell (12) which are made of a shell material, and a core structure (16) that fills an interior of the shell (12) and is made of a core material. The invention further relates to a corresponding compact component that can be produced by means of the method.

The invention relates to a method for producing, in particular for at least partially generatively producing, a compact component comprising a shell and a core structure that fills an interior of the shell. A further aspect of the invention relates to such a component that can be produced by means of the method.

Generative production methods are characterized by the construction of components made from formless, particularly powdered materials. These are therefore material-constructing methods, whereas material-removing production methods basically produce the component from semi-finished products or compact workpieces. In addition, generative production methods dispense with molds. The generative production methods of the group of beam melting methods are able to produce highly complex component geometries. According to VDI guideline 3404 the following methods are grouped under the generic term of beam melting: laser forming, selective laser melting (SLM), lasercusing, electron beam melting (EBM) and direct metal laser sintering (DMLS).

In particular, the process of constructing the entire component geometry generatively in a beam melting method is known. The necessary component information is first provided in the form of 3D CAD data prior to the actual production. The CAD component model is then broken down mathematically into layers lying on top of one another (layer planes) of a specified layer thickness using special software (this process is also referred to as slicing), and the layers are broken down into individual laser vectors (hatching). The subsequent beam melting method comprises three cyclically repeating phases. In the first phase, a substrate plate is lowered by the predetermined layer thickness in accordance with the slice operation previously carried out. In the second phase, a layer of the material in powder form is applied to the substrate plate with a coater. In the third phase, the contour surfaces of the component in the applied powder layer are completely fused locally using a laser, for instance a diode-pumped solid-state fiber laser, in accordance with the laser vectors determined. Depending on the material, melting or sintering of the material and, therefore, solidification of the powdery material is carried out according to the component geometry of the layer. These steps are repeated until the final component layer is produced. The solidified structure is then removed from the non-solidified powder which can be processed and fed back into the generative process.

In a further development of the procedure described above, the melt of a pure metal or a metal alloy can be poured into the outer shell of a component thus produced, in order to form a core structure. In this context, the use of copper or aluminum alloys, for example, as the core material is known. The result is, for example, mold inserts which achieve a uniformly high cooling effect due to the good thermal conductivity of the core.

In order to increase the construction rate of generative production methods, the process of deliberately increasing the laser power, wherein a laser power of approximately 1 kW is currently obtained, is also known. Since increasing the power when the laser beam diameter remains constant results in an increased spatter formation, the beam diameter is increased to up to 1 mm in this attempt at a solution and the existing beam profile, which corresponds to a Gaussian distribution, is scattered. A multi-beam concept can be used, which allows processing with different laser powers and focus diameters, in order to counter the decline in the surface quality.

Depending on the material system processed, the process of constructing so-called green bodies using generative production methods, which are subjected to thermal treatment in a subsequent process step in order to increase the strength, is also known. Such a thermal treatment is absolutely essential for most composite materials or ceramic material systems, which is detrimental to the use of these methods in mass production.

DE 10 2005 055 524 A describes a method for the production of a hollow body, for example for dental ceramics, wherein a green body made of a powder material such as, for example, SiO₂ having a profiled surface contour is produced by conventional reshaping methods, such as pressing or casting, by material-removing methods or by application methods such as 3D printing or deposition, and then the surface is sintered by laser irradiation and thus solidified. Finally, loose, non-sintered material in powder form is removed.

In addition, nanoparticulate or nanostructured materials are known as joining materials for connecting components.

A joining method for connecting two components in which a layer of a nanostructured or microstructured material is applied between the joining surfaces of the components, and an exothermic reaction of the nanostructured or microstructured material is then triggered, is known from DE 10 2007 020 389 A1. The release of heat results in a partial fusing and bonding of the component material. Layers of a joining material can optionally be applied between the nanostructured or microstructured material and the joining surfaces of the components.

In the joining method for producing a metal-ceramic composite substrate, which is known from DE 10 2006 009 159 A, a layer of a sintered material is applied between the components to be connected, and this is subsequently sintered at a high temperature and high pressure.

A soldering material in the form of a dispersion is known from DE 10 2008 037 263 A, which comprises a dispersion agent and a soldering powder dispersed therein. The soldering powder consists of nanoparticles of a metal having mean particle diameters in the range of 20 nm to 40 nm. The dispersion agent can optionally comprise a polymeric reactive resin which undergoes a crosslinking reaction under the action of heat. The soldering material is used for joining two components during heat treatment.

U.S. Pat. No. 6,033,624 describes different methods for the production of nanoparticular metal, metal carbide, or metal alloy powders as well as the consolidation thereof to form a nanostructured material in a mold by compression, in particular by using a vacuum heat press.

The current low construction rates in the range of 5 to 20 cm³/h constitute an obstacle to using modern generative production methods for mass production. In order to extend the field of application of the methods to the production of prototypes and individual parts, it is desirable to increase the construction rate. In addition, the workpieces constructed generatively by means of today's methods from selected material systems such as, for example, ceramic materials frequently do not achieve the necessary component properties for mass production of end products.

Therefore, the object which forms the basis of the invention is to propose a method for the generative construction of a compact component, which is characterized by an increased construction rate and improved material properties.

This object is achieved by a method for producing a compact component, and by a component that can be produced by means of the method having the features of the independent claims.

The compact component according to the invention comprises a shell and optionally a grid structure situated inside the shell which are made of a shell material. According to the invention the component further comprises a core structure that substantially fills an interior of the shell completely and is made of a core material. The core material of the core structure is, in particular, a material produced from a nanoparticulate material. The shell material and/or the core material can be identical or different. They are preferably selected from the group consisting of metallic materials, ceramic materials and/or glass materials.

By filling the interior of the component with a core material formed from a nanoparticulate material, a compact component is obtained which is clearly superior, in terms of its physical and mechanical properties, to components produced from conventional powdery materials having particle diameters in the range of micrometers. In particular, components with outstanding stability and strength are produced. It is mainly thanks to the integration of metallic grid structures of high tensile strengths inside a hard and/or brittle core material that it is possible to produce components which combine the advantages of both groups of materials. High density, low porosity, high strength and improved optical and thermal properties of the workpieces to be constructed can be achieved with the present method.

The differentiation of the component into a shell and, possibly, the internal grid structure, on the one hand, and the core matrix, on the other hand, makes it possible to produce three-dimensional workpieces with a highly complex geometry from complex composite materials. This combination makes it possible to selectively adjust the component properties and adapt them to different requirements. In terms of multi-functional components, the shell and, possibly, the internal grid structure can be tailored to a specific functionality of the workpiece to be constructed by suitable selection of the materials and the three-dimensional shape. In this case, the material and the shape of the core structure can differ accordingly from the shell.

The method according to the invention for producing such a compact component comprises the following steps:
(a) generative construction of at least one layer of the shell that runs along a sectional plane of the component and optionally at least one layer of the grid structure using a particulate material of the shell material or of at least one precursor of the same by means of a beam melting method; and
(b) melting, sintering and/or solidification of a nanoparticulate material of the core material, which is situated in the interior of the at least one layer of the shell or of at least one precursor of the same, for forming the core structure of the component.

The use of the nanoparticulate material leads to a considerable reduction in the activation energy due to the large specific surface of nanoparticles. As a consequence, the energy input for the activation of the reaction of the material, which is required for the melting, sintering and/or solidification in step (b), is reduced. The associated shorter time for the melting, sintering and/or solidification also leads to a significant increase in the construction rate of the component. In addition, nanoparticles have a significantly higher reactivity than, for example, microparticles. If, therefore, the core material to be generated is not used in its final chemical structure as a material, but a chemical precursor (precursor), the amount of energy required to initiate the chemical conversion will be even further reduced. Overall, reducing the required energy input and accelerating the construction rate (reducing the overall production time) result in significant economic benefits in production.

The term ‘grid structure’ is used within the context of the present invention to denote a delicate, two-dimensional or three-dimensional, regular or irregular structure relative to an average wall thickness of the shell structure, which is composed of fine, periodic, for example rod-shaped, threadlike or ribbonlike elements, or non-periodic elements such as cellular and foam-like structures. The grid structure can, for example, comprise a net-like or mesh-like structure. The grid structure preferably extends completely through the shell, i.e. from one end of the shell to the other end. The intermediate spaces present within the grid structure are preferably connected to one another, and preferably completely filled with the core material.

It is understood that the term ‘material’ can also include mixtures of materials consisting of multiple components. Master alloys can also be used amongst others. The advantage of these is that the melting point can be considerably reduced. Consequently, the activation energy can be further reduced.

According to an advantageous embodiment of the method the material of the shell material, which is used for the generative construction of the shell and the grid structure, is also used in nanoparticulate form. This results in additional benefits in terms of the energy requirement and the construction rate of the method as well as the material properties of the component, which have already been discussed above. In contrast, powdery materials having average particle diameters in the range of 10 μm or larger are conventionally used for the generative construction of components using beam melting methods.

The nanoparticulate material of the shell material and/or of the core material preferably has an average particle diameter in the range of 1 to 500 nm. It is particularly preferred that materials with an average particle diameter in the range of 1 to 100 nm, preferably in the range of 5 to 50 nm, are used, by which it is meant that at least one external dimension of a particle lies within these ranges. In this case, at least 50%, in particular at least 60%, preferably at least 70% of the nanoparticulate material of the shell material and/or of the core material can have the average particle diameters indicated, based on the number of particles. The nanoparticles can have a substantially spherical shape, but also other desired configurations; they can be present in a free, unbonded state or as an aggregate or agglomerate.

The particulate material of the core material and/or of the material of the shell material generally comprises particles, particularly nanoparticles. In this case, the material is used in the form of a powder which can be present in different forms. In particular, the powder can be applied dry, as granules, in a suspension, as a paste or in other forms.

In the case of the generative construction of the shell and, possibly, the grid structure which takes place in step (a), a beam melting method, preferably the selective laser melting method (SLM), is used. In this case, step (a) comprises the steps of
(a1) applying a layer of the particulate material of the shell material or of at least one precursor thereof, and
(a2) melting, sintering and/or solidification of the first material for forming a layer of the shell and, possibly, at least the grid structure by irradiating laser light according to a contour of the component along the sectional plane of the component.

It is understood that the laser is controlled by computer, with recourse being had to 3D data of the component to be produced, which has been processed by the techniques of slicing and hatching described above.

The method according to the invention can, in principle, be carried out according to two different work methods, namely by means of a sequential construction, wherein firstly the shell and, possibly, the grid structure, and then the core structure are formed, or a synchronous (parallel) construction of the components indicated.

In accordance with the sequential procedure, the shell and, if applicable, the grid structure are firstly generatively constructed in layers by repeating the above steps (a1) and (a2), up to a certain component height of the component, preferably the final height of the component. Subsequently, the interior (which is freed from the non-solidified material of the shell material) of the shell is filled with the nanoparticulate material of the core material or at least of its precursor, and this material is reacted by melting, sintering and/or solidification to produce the core structure of the component. As nanoparticulate materials in powder form only have a very low tendency to trickle, the filling of the shell with the nanoparticles can be supported in this procedure by applying ultrasound to the component or by injecting air. This procedure is especially recommended in the case of a fine-particle internal grid structure or in the case of very complex component geometries. During sequential production the same material can be used for the core material and the shell material, or different materials can be used for these components.

In the synchronous procedure, the production of the shell and, if applicable, the grid structure, and the production of the core structure are carried out in parallel in layers, wherein steps (a) and (b) are repeated until a predetermined component height of the component is reached. In the case of the synchronous production method the plan is preferably to use the same material for the shell material and for the core material. Thus, for each individual applied layer of the material (step (a1)), the corresponding layer of the shell and, possibly, the grid structure are initially solidified (step (a2)) and then the residual layer of material remaining in the interior is solidified (step (b)). These steps are repeated until the component is completed, with the production preferably concluding with step (a), if a closed shell is to be produced. The production of the core structure from a different material to the shell material is, in principle, not excluded in the case of the synchronous method either, because of the requirement for the removal of the material of the shell material, in each case, following the solidification of the shell and, possibly, the grid structure, but this is significantly more expensive and therefore less preferred.

In principle, in the case of all the method variants, the material used can contain particles consisting of the actual core material or shell material, i.e. in the final chemical form of the respective materials to be produced. In this case, the solidification in step (b) or step (a2) is carried out by melting and/or sintering and subsequent solidification, without a chemical change in the material.

According to a preferred embodiment, however, the material of the core material and/or of the shell material comprises at least one precursor of the core material or of the shell material. In this case, an exothermic chemical reaction of the precursor to produce the core material or shell material is triggered by a suitable energy input, as a result of which the melting, sintering and/or solidification in step (b) or in step (a2) take(s) place. For example, the at least one reactant can comprise two or more metals which form an intermetallic phase with one another by way of the exothermic reaction. For example, the material can comprise a mixture of titanium and aluminum, which reacts to form a titanium aluminide such as Ti₃Al, TiAl or TiAl₃. Further examples include a nickel/aluminum mixture, which reacts to form Ni₃Al, a nickel/titanium mixture which reacts to form NiTi, a copper/tin mixture which reacts to form Cu₃Sn or Cu₃Sn₅, a niobium/tin mixture which forms the intermetallic phase Nb₃Sn and many such like products. It is also possible that the material of the core material and/or of the shell material comprises a metal as a precursor which is capable of forming an oxide in the presence of atmospheric oxygen. For example, particulate silver can be used, which reacts to produce silver oxide Ag₂O. If reactive reactants are used as the material, the nanoparticulate structure has a particularly advantageous effect, as nanoparticles have a substantially higher reactivity and therefore a lower energy input is required to initiate the chemical conversion.

The melting, sintering and/or solidification in step (b) is carried out in particular, if a precursor of the final material is used as the material due to local, initial initiation and triggering of an exothermic chemical reaction, which continues in a self-sustaining manner through the entire material. The heat released by way of the exothermic reaction results in fusion and, possibly, sintering of the nanoparticulate material and its solidification. The triggering of such a reaction by initiation is generally known (see for example DE 10 2007 020 389 A1). In principle, in the case of all the materials which can be used, the melting, sintering and solidification can also be caused by an external heat supply or pressure supply, for instance in a furnace, possibly in a controlled atmosphere.

Further advantageous embodiments of the invention form the subject matter of the other subordinate claims. The invention will be explained in more detail below in embodiments with reference to the accompanying drawings, where:

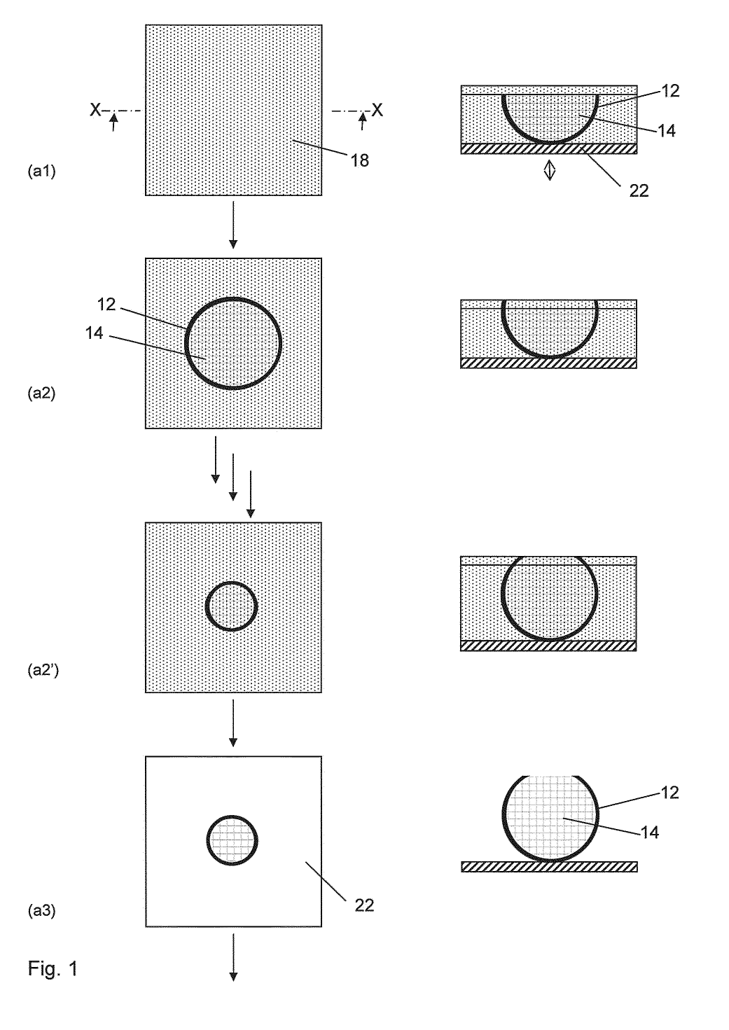

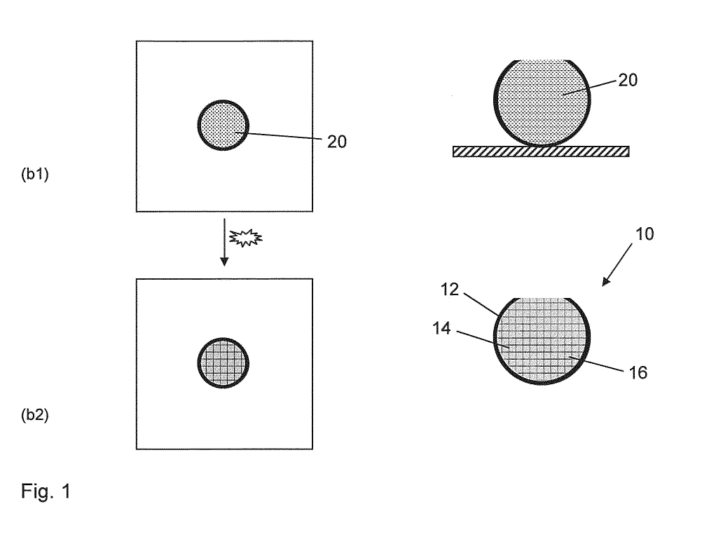

FIG. 1 shows an example of a procedure for producing a compact component with sequential production of the shell and the core structure according to a first embodiment of the invention;

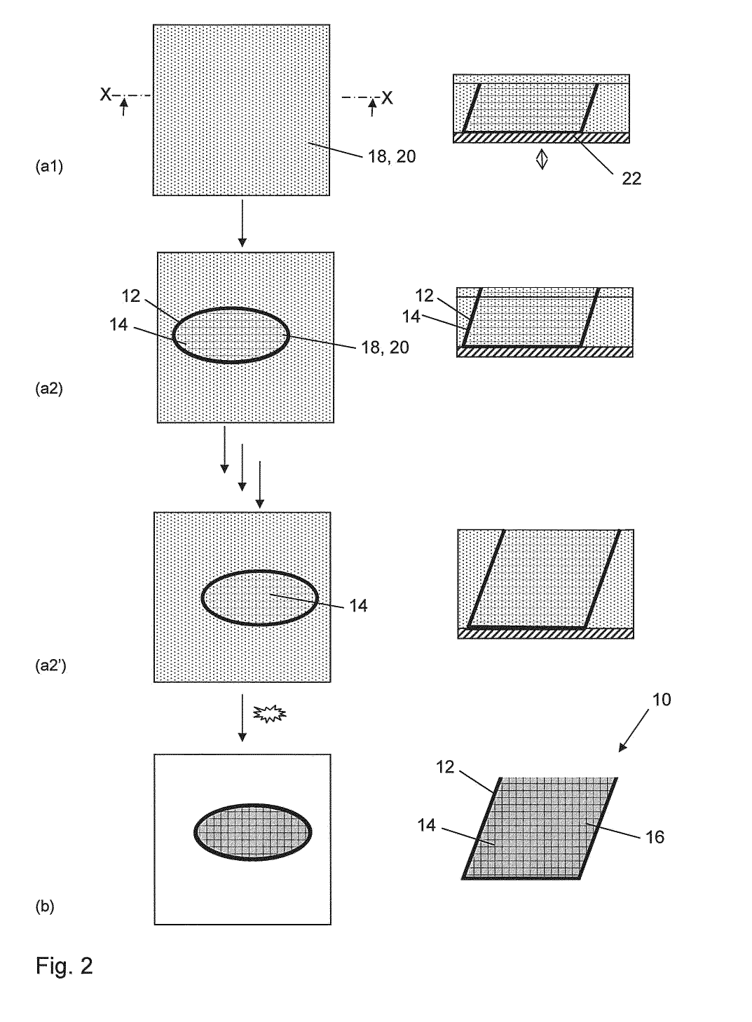

FIG. 2 shows an example of a procedure for producing a compact component with sequential construction of the shell and the core structure according to a second embodiment of the invention; and

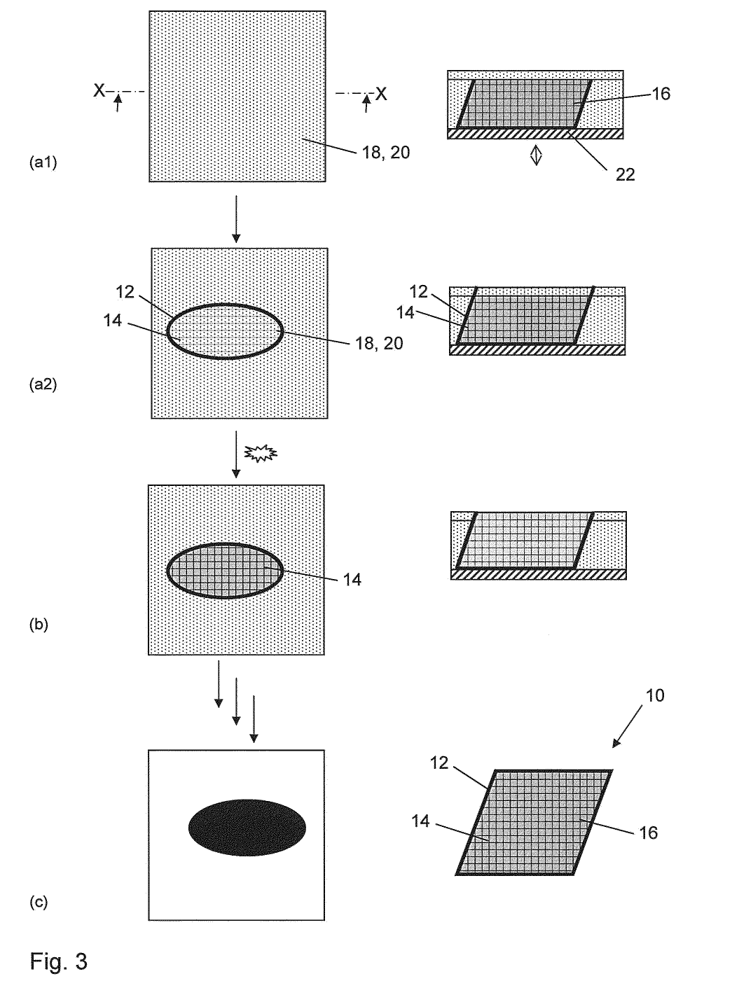

FIG. 3 shows an example of a procedure for producing a compact component with synchronous construction of the shell and the core structure according to a third embodiment of the invention.

FIG. 1 shows a diagrammatic representation of the various process steps of the method according to a first embodiment of the invention, wherein the shell and, possibly, the grid structure and the core structure of the component are constructed sequentially. A top view of the work area is shown in the left column and a sectional view along plane X-X (see step (a1)) is shown in the right column, respectively.

The construction of the finished component, which is shown in the last process step (b2) on the right side, is to be described first. The component which is designated 10 overall shown in the example is a substantially spherical shape. It comprises a substantially spherical ball cup-shaped shell 12 which encloses the entire volume with the exception of an open portion shown at the top. Inside the shell 12 is arranged a grid structure 14 which extends substantially through the entire interior of the shell. The shell 12 as well as the grid structure 14 are made of the same material, which is designated here as the shell material. The interior of the shell 12 or the intermediate spaces of the grid structure 14 is/are substantially completely filled with a core structure 16 which, in the present example, consists of a different material to the shell 12 or the grid structure 14. Alternatively, the core structure 16 can, however, also consist of the same material as the shell 12.

It is understood that the relatively simple component geometries of the components according to FIGS. 1 and 2 are merely examples to explain the principle of the method. Of course, substantially more complex component geometries can also be produced with the procedures presented.

The process stage shown in step (a1) of FIG. 1 constitutes a phase in which some method cycles have already been run through and therefore a certain component height has already been constructed. In step (a1), a layer of a particulate material 18 of the shell material or a (reactive) precursor of the same is applied to a vertically movable work surface 22. The material 18 can be in nanoparticulate form. The particulate material 18 can be used as a dry powder, as granules, as a suspension, as a paste or the like. Suitable materials are metals and metal alloys, metal oxides, ceramics or glass materials or their chemical precursor compounds (precursors). A typical layer thickness of a layer applied in step (a1) is in the range of 10 to 100 μm and is, for example, 30 μm in a typical case. It can be seen on the right side of step (a1) that the layer of material 18 is still resting, unprocessed, on the already partially finished component. The component is located on a vertically adjustable work surface 22. In the diagram the newly applied layer is separated by a horizontal line from the rest of the work area, and the thickness thereof is exaggerated.

In the subsequent step (a2), the component contour is removed according to previously determined laser vectors in the material 18 by means of a computer-controlled laser which is not shown, in particular a diode-pumped solid-state fiber laser. This results in complete fusion and/or sintering of the material 18 locally and its subsequent solidification, as a result of which a layer of the shell 12 and the grid structure 14 is produced. The work surface 22 is then lowered by the specified layer height and steps (a1) and (a2) are carried out again for the subsequent layer of the component which is to be constructed. The steps (a1) and (a2) are repeated until such time as a predetermined component height is reached (see step (a2′)).

Then, in a subsequent step (a3), the non-solidified material 18, which is located inside and outside the component 10, is removed. This process can be facilitated by exposure to ultrasound, or by using compressed air. What remains is a substantially hollow shell 12, through which the grid structure 14 extends.

Following the completion of the process steps (a1) to (a3), during which the shell 12 and the grid structure 14 are constructed, the core structure 16 is then produced. For this purpose, the interior of the shell 12 is filled with a nanoparticulate material 20 of the core material or of at least one precursor of the same in step (b1). The nanoparticulate material 20 can be used as a dry powder, as granules, as a suspension, as a paste or the like. Suitable materials are metals and metal alloys, metal oxides, ceramics or glass materials or their chemical precursor compounds (precursors). In order to facilitate complete filling of the interior with the material 20, the component can be acted upon with ultrasound or the distribution of the material 20 can be supported by air injection.

The core structure 16 of the component 10 is subsequently formed in step (b2), in that the nanoparticulate material 20 is melted, sintered and/or solidified in a shrinkage-compensating manner. If the nanoparticulate material 20 is already the actual core material, the temperature required for the melting or sintering can be represented by an external heat supply, for example in a furnace. In the case of a reactive precursor of the core material, the reaction to form the core material can also be triggered by local initiation. The exothermic reaction which starts continues through the entire material 20, resulting in the heating thereof and therefore the melting or sintering thereof.

Steps (b1) to (b2) therefore include the production of the core structure 16. Deviating from the illustrated procedure, in which the entire core structure 16 is produced by a single execution of steps (b1) and (b2), this can also be performed in stages, for example in two to four stages. This can be particularly used for very complex component structures.

A second embodiment of the method according to the invention is shown in FIG. 2, in which the shell 12, the grid structure 14 and the core structure 16 of the component 10 are made of the same material. The illustrated method is a variant of the method according to

FIG. 1. The differences from the first embodiment according to FIG. 1 will mainly be dealt with, wherein the same reference numerals are used for elements corresponding to those in FIG. 1.

The component 10 of this example is an inclined cylinder with an elliptical area (see FIG. 2 (c)).

The procedure illustrated again shows a phase in step (a1), in which the component is already partially produced. In step (a1) a layer of a nanoparticulate material 18 of the shell material, which is simultaneously the material 20 for the core material, is applied to the already partially produced component. In the subsequent step (a2)—as already explained in FIG. 1—a layer of the shell 12 and the grid structure 14 are constructed using the SLM method. The steps (a1) and (a2) are repeated until such time as the desired height of the component is finally reached in step (a2′).

Deviating from the embodiment according to FIG. 1 explained above, the material 20 situated inside the constructed structure is not removed following the completion of the generative construction of the shell structure 12 and the grid structure 14. Instead, the material 20 of the core material, which as indicated here is identical to the material 18 of the shell material, remains inside the geometry and is then solidified, in a subsequent step (b), by melting, sintering and/or other solidification method. As already described above, an external heat supply can be provided or an exothermic chemical reaction can be initiated locally for this purpose.

A third embodiment of the method according to the invention is shown in FIG. 3, in which the shell 12, the grid structure 14 and the core structure 16 of the component 10 are constructed synchronously and in layers. The differences from the first embodiment according to FIG. 1 will be essentially dealt with, with similar reference numerals being used for elements corresponding to those in FIG. 1.

As in FIG. 2, the component 10 of this example is an inclined cylinder with an elliptical area (see FIG. 3 (c)).

The procedure illustrated again shows a phase in step (a1), in which the component is already partially produced. Unlike the previous description, the core structure 16 is also already formed up to the current work height (see step (a1), right side) in the partially finished component. A layer of a nanoparticulate material 18 of the shell material, which, in this case, is simultaneously the material 20 for the core material, is applied to the already partially produced component in step (a1). In the subsequent step (a2)—as already explained in FIG. 1—a layer of the shell 12 as well as the grid structure 14 are constructed using the SLM method.

Deviating from the embodiment according to FIG. 1 or 2 which is explained above, the corresponding layer of the core structure 14 is then produced by melting, sintering and/or solidification of the material 20 of the core material, which, as indicated here, is identical to the material 18 of the shell material, in a subsequent step (b). As already described above, an external heat supply can be provided or an exothermic chemical reaction can be initiated locally for this purpose

The steps (a1) to (b) are repeated until a predetermined height of the component, in particular the final component height of the component 10, is reached.

In the example shown, the method ends with the production of the uppermost layer of the shell 12, as shown in step (c). It is understood that step (c) substantially comprises the process steps (a1) and (a2) in order to produce the shell 12, namely the application of a further layer of the material 18, 20 and the solidification thereof using the SLM method.

It can be seen from the procedures shown by way of examples that the method according to the invention is a combined beam melting method. While the shell 12 and, possibly, the grid structure 12 is/are produced by beam melting, the core structure 16 is shown with a different technique.

Even if identical materials are used for the shell 12 and, possibly, the grid structure 12, on the one hand, and the core structure 16, on the other hand, the component produced using the method according to the invention, wherein at least the core structure is produced from a nanoparticulate material, can be clearly distinguished from components produced using a conventional method by means of a suitable analytical method. In particular, microsectional analysis in order to determine the phase and laser-induced breakdown spectroscopy (LIBS) in order to analyze the construction and structure should be indicated. Furthermore, the materials used, particularly the alloy elements used, can be demonstrated by EDX analysis or microsectional analysis, the composite structure of a single component material can be demonstrated by means of microsectional analysis for phase determination, the composite structure of a multi-component material can be demonstrated by means of CT testing or ultrasonic testing, and the elemental composition can be demonstrated by X-ray fluorescence analysis.

The method according to the invention can both be used to produce new components and to repair or overhaul components. Possible areas of application include medical technology, mechanical engineering, the rubber and plastic processing industries, vehicle construction, electrical engineering, the metal industry, ceramic composite materials, high-temperature composite materials, precision engineering, measurement, control and regulation technology, and many more.

### LIST OF REFERENCE NUMERALS

10 Component

12 Shell

14 Grid structure

16 Core structure

18 Material for the shell material

20 Material for the core material

22 Work surface

What is claimed is:

1. A method for producing a compact component (10) comprising a shell (12) and optionally a grid structure (14) situated inside the shell (12) which are made of a shell material, and a core structure (16) that fills an interior of the shell (12) and is made of a core material, wherein the method comprises the following steps:
(a) generative construction of at least one layer of the shell (12) that runs along a sectional plane of the component (10) and optionally at least one layer of the grid structure (14) using a particulate material (18) of the shell material or of at least one precursor of the same by means of a beam melting method; and
(b) melting, sintering and/or solidification of a nanoparticulate material (20) of the core material, which is situated in the interior of the at least one layer of the shell (12), or of at least one precursor of the same, for forming the core structure (14) of the component (10).

2. The method according to claim 1, wherein the material (18) of the shell material also has a nanoparticulate form.

3. The method according to claim 1, wherein the nanoparticulate material of the shell material and/or the core material has an average particle diameter in the range of 1 to 500 nm, in particular in the range of 1 to 100 nm, preferably in the range of 5 to 50 nm.

4. The method according to claim 3, wherein at least 50%, in particular at least 60%, preferably at least 70%, of the nanoparticulate material of the shell material and/or the core material has average particle diameters in the range of 1 to 500 nm, in particular in the range of 1 to 100 nm, preferably in the range of 5 to 50 nm.

5. The method according to claim 1, wherein step (a) comprises the following steps: (a1) application of a layer of the particulate material (18) of the shell material or of at least one precursor of the same and (a2) melting, sintering and/or solidification of the first material for forming a layer of the shell (12) and optionally at least the grid structure (14) by irradiating laser light according to a contour of the component along the sectional plane of the component (10).

6. The method according to claim 5, wherein the shell (12) and, if applicable, the grid structure (14) are initially constructed generatively in layers by repetitions of the steps (a1) and (a2) up to a predetermined component height of the component, then (b1) the interior of the shell (12) is filled with the nanoparticulate material (20) of the core material or of at least one precursor of the same, and (b2) the core structure (14) of the component (10) is formed by melting, sintering and/or solidification.

7. The method according to claim 1, wherein the production of the shell (12) and, if applicable, the grid structure (14) and of the core structure (16) is carried out synchronously in layers, wherein the steps (a) and (b) are repeated until a predetermined component height of the component (10) is reached.

8. The method according to claim 7, wherein the materials of the shell material and the core material are identical.

9. The method according to claim 1, wherein the material of the core material and/or of the shell material comprises at least one precursor of the core material or of the shell material, and the melting, sintering and/or solidification in step (b) or in step (a2) takes place by triggering an exothermic chemical reaction of the at least one precursor to form the core material or the shell material.

10. The method according to claim 9, wherein the at least one precursor comprises metals which form an intermetallic phase with one another by way of the exothermic reaction, or which form a metal oxide with atmospheric oxygen.

11. The method according to claim 1, wherein the melting, sintering and/or solidification in step (b) is triggered by initiating a chemical reaction of the at least one precursor of the core material or by an external heat supply and/or pressure supply.

12. The method according to claim 6, wherein the filling with the nanoparticulate material (20) of the core material in step (b1) is supported by ultrasound, or by air injection.

13. A compact component (10) producible by means of a method according to claim 1, comprising a shell (12) and optionally a grid structure (14) situated inside the shell (12) which are made of a shell material, and a core structure (16) that fills an interior of the shell (12) and is made of a core material.

14. The compact component (10) according to claim 13, wherein the shell material and/or the core material is/are selected independently of one another from the group consisting of metallic materials, ceramic materials and/or glass materials, and are identical or different.
